(19) United States
(12) Patent Application Publication
(10) Pub. No.: US 2026/0031561 A1
(43) Pub. Date: Jan. 29, 2026

(54) ELECTROPLATED PART, METHOD FOR MANUFACTURING ELECTROPLATED PART AND CONNECTOR

(71) Applicant: Tyco Electronics (Shanghai) Co., Ltd., Shanghai (CN)

(72) Inventors: Zhenyu (Julie) Zhu, Shanghai (CN); Keke Gan, Shanghai (CN); Zhongxi Huang, Shanghai (CN); Jialin Zhang, Shanghai (CN)

(73) Assignee: Tyco Electronics (Shanghai) Co., Ltd., Shanghai (CN)

(21) Appl. No.: 19/278,976

(22) Filed: Jul. 24, 2025

(30) Foreign Application Priority Data
Jul. 25, 2024 (CN) 202411011086.8

(51) Int. Cl. H01R 13/03; H01R 43/16

(52) U.S. Cl. CPC H01R 13/03; H01R 43/16

(57) ABSTRACT

An electroplated part includes a substrate, a nickel plating layer formed on a surface of the substrate, a tin-graphite composite plating layer formed on the nickel plating layer, and a tin plating layer formed on the tin-graphite composite plating layer. The nickel plating layer is a base plating layer of the substrate. The tin plating layer is an outer plating layer of the substrate and the tin-graphite composite plating layer is an intermediate plating layer of the substrate.

### CROSS-REFERENCE TO RELATED APPLICATION

This application claims the benefit of the filing date under 35 U.S.C. § 119(a)-(d) of Chinese Patent Application No. 202411011086.8, filed on Jul. 25, 2024.

### FIELD OF THE INVENTION

The present invention relates to an electroplated part, a method for manufacturing the electroplated part and a connector comprising the electroplated part.

### BACKGROUND OF THE INVENTION

A plating layer structure on a connector terminal typically includes a nickel plating layer and a tin plating layer formed on the nickel plating layer. The tin plating layer has low contact resistance and serves as the outermost contact layer of the connector terminal. However, the tin plating layer has a high friction coefficient, resulting in high insertion or mating force and poor wear resistance of the terminal. With the improvement of application requirements, all the industrial sectors put forward higher requirements on high wear resistance and low insertion/extraction force of terminals or connectors. The existing plating layer structures of terminals can no longer meet the requirements.

Siemens in Germany and Dowa in Japan have successively developed tin-graphite composite coatings, which are used as the outermost layer of a connector terminal. However, since graphite has a large particle size, many graphite particles will be exposed from a tin-graphite composite plating layer to the air to different extents, especially most of the graphite particles on the surface are exposed outside the tin-graphite composite plating layer. This creates two problems. The first problem is that the corrosion resistance of tin graphite will be greatly reduced. This is because there is a large potential difference between tin and graphite, which can cause galvanic corrosion; moreover, the surface area and roughness of the tin-graphite composite plating layer are greatly increased, which makes it easier to absorb electrolyte and produce corrosion. The second problem is that, when the tin-graphite composite plating layer is exposed to external forces, graphite particles are easily separated from the plating layer, which greatly reduces the amount of graphite in the composite plating layer and thus the lubrication and wear reduction effect of graphite, thereby failing to achieve the expected purpose of reducing the friction coefficient.

### SUMMARY OF THE INVENTION

An electroplated part includes a substrate, a nickel plating layer formed on a surface of the substrate, a tin-graphite composite plating layer formed on the nickel plating layer, and a tin plating layer formed on the tin-graphite composite plating layer. The nickel plating layer is a base plating layer of the substrate. The tin plating layer is an outer plating layer of the substrate and the tin-graphite composite plating layer is an intermediate plating layer of the substrate.

### BRIEF DESCRIPTION OF THE DRAWINGS

Features of the present invention will become more apparent by describing in detail exemplary embodiments thereof with reference to the accompanying drawings, in which:

FIG. 1 shows a schematic diagram of a substrate according to an exemplary embodiment of the present invention;

FIG. 2 shows a schematic diagram of the formation of a nickel plating layer on the substrate shown in FIG. 1;

FIG. 3 shows a schematic diagram of the formation of a tin-graphite composite plating layer on the nickel coating of the substrate shown in FIG. 2; and

FIG. 4 shows a schematic diagram of the formation of a tin plating layer on the tin-graphite composite plating layer of the substrate shown in FIG. 3.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

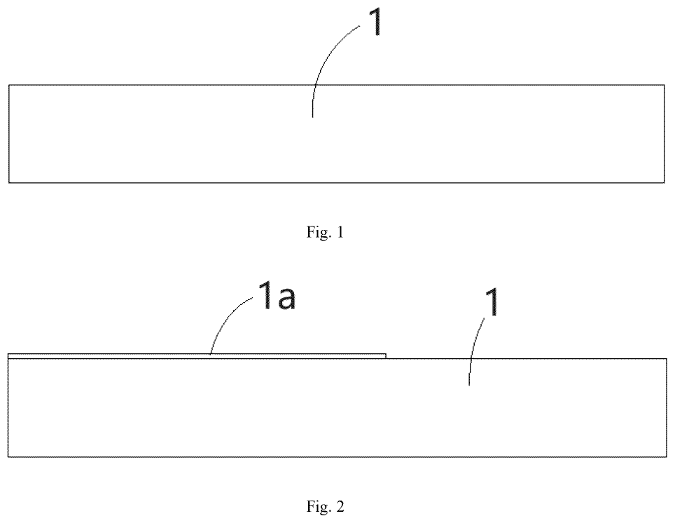

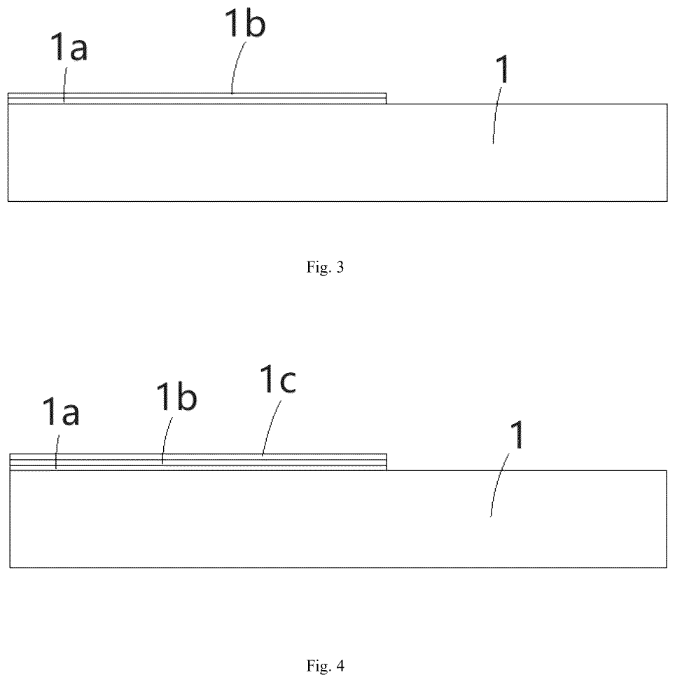

As shown in FIGS. 1 to 4, in an exemplary embodiment of the present invention, an electroplated part is disclosed. The electroplated part includes a substrate 1, a nickel plating layer 1a, a tin-graphite composite plating layer 1b and a tin plating layer 1c. The nickel plating layer 1a is formed on a surface of the substrate 1. The tin-graphite composite plating layer 1b is formed on the nickel plating layer 1a. The tin plating layer 1c is formed on the tin-graphite composite plating layer 1b. The nickel plating layer 1a serves as a base plating layer of the substrate 1, the tin plating layer 1c serves as an outer plating layer of the substrate 1, and the tin-graphite composite plating layer 1b serves as an intermediate plating layer of the substrate 1.

In the illustrated embodiment, some of graphite particles in the tin-graphite composite plating layer 1b are exposed from a surface of the tin-graphite composite plating layer 1b, and the graphite particles exposed from the surface of the tin-graphite composite plating layer 1b are partially or completely wrapped with the tin plating layer 1c.

In an exemplary embodiment of the present invention, the thickness of the tin plating layer 1c is less than the maximum diameter of the graphite particles in the tin-graphite composite plating layer 1b, so that the tin plating layer 1c only partially wraps the graphite particles exposed from the tin-graphite composite plating layer 1b. In another exemplary embodiment of the present invention, the thickness of the tin plating layer 1c is equal to or greater than the maximum diameter of the graphite particles in the tin-graphite composite plating layer 1b, so that the tin plating layer 1c completely wraps the graphite particles exposed from the tin-graphite composite plating layer 1b.

In the illustrated embodiment, the nickel plating layer 1a has a thickness of 0.5-2.5 um, the tin-graphite composite plating layer 1b has a thickness of 0.5-15 um, the tin plating layer 1c has a thickness of 0.5-5 um, and the graphite particles in the tin-graphite composite plating layer 1b have a diameter of 0.5-5 um.

In an embodiment, the substrate 1 is a conductive substrate or a non-conductive substrate. In an embodiment, the substrate 1 is a metal substrate 1 or a non-metal substrate 1. In the illustrated embodiment, the electroplated part is a connector terminal, and the substrate 1 is a copper substrate or a copper alloy substrate.

As shown in FIGS. 1 to 4, in the illustrated embodiment, the nickel plating layer 1a, the tin-graphite composite plating layer 1b and the tin plating layer 1c are selectively electroplated onto a local region of the substrate 1 or on the entire surface of the substrate 1.

In another exemplary embodiment of the present invention, a method for manufacturing an electroplated part is disclosed. The method for manufacturing an electroplated part includes the following steps:
S10: providing a substrate 1;
S20: forming a nickel plating layer 1a on the substrate 1;
S30: forming a tin-graphite composite plating layer 1b on the nickel plating layer 1a; and
S40: forming a tin plating layer 1c on the tin-graphite composite plating layer 1b.

The nickel plating layer 1a serves as a base plating layer of the substrate 1, the tin plating layer 1c serves as an outer plating layer of the substrate 1, and the tin-graphite composite plating layer 1b serves as an intermediate plating layer of the substrate 1.

In an embodiment, the afore-mentioned step S10 includes: S11: removing dirt and grease from a surface of the substrate 1; and S12: pickling and activating the substrate 1.

In an illustrated embodiment, in step S11, the substrate 1 is subjected to degreasing by cathodic electrolysis for 1 minute by using a direct current having a current density of 2 A/dm², so as to remove the dirt and grease from the surface of the substrate 1. In step S12, the substrate 1 is pickled and activated in 5% dilute sulfuric acid.

In an embodiment, the afore-mentioned step S20 includes:
S21: preparing a nickel aminosulfonate electroplating solution and heating the prepared nickel aminosulfonate electroplating solution to 60° C.;
S22: placing the substrate 1 into the nickel aminosulfonate electroplating solution and electroplating the substrate 1 by using a direct current having a current density of 2 A/dm²; and
S23: taking out the substrate 1 from the nickel aminosulfonate electroplating solution and cleaning the substrate 1 with deionized water.

In an embodiment, the afore-mentioned step S30 includes:
S31: preparing a tin methanesulfonate-graphite electroplating solution, wherein the graphite is flaky graphite and has an average particle size of 3-5 um, and the graphite content is 20 g/L;
S32: mechanically stirring the tin methanesulfonate-graphite electroplating solution for 1 hour until the graphite is uniformly dispersed in the tin methanesulfonate-graphite electroplating solution;
S33: heating the tin methanesulfonate-graphite electroplating solution to 55° C. and placing the substrate 1 that has been plated with the nickel plating layer 1a into the tin methanesulfonate-graphite electroplating solution;
S34: subjecting the substrate 1 to tin-graphite composite plating using a pulsed current having a peak current density of 5-40 A/dm², a pulse width of 10 ms and a duty cycle of 2%, and wherein the electroplating duration is 60 seconds; and
S35: taking out the substrate 1 from the tin methanesulfonate-graphite electroplating solution and cleaning the substrate 1 with deionized water.

In an embodiment, the afore-mentioned step S40 includes:
S41: preparing a tin methanesulfonate electroplating solution and heating the prepared tin methanesulfonate electroplating solution to 55° C.;
S42: placing the substrate 1 which has been plated with the nickel plating layer 1a and the tin-graphite composite plating layer 1b into the tin methanesulfonate electroplating solution;
S43: electroplating the substrate 1 by using a direct current having a current density of 2 A/dm² for 60 to 120 seconds; and
S44: taking out the substrate 1 from the tin methanesulfonate electroplating solution, cleaning the substrate 1 with deionized water and air drying the substrate 1 by using an air drying device.

In an embodiment, the electroplated part is a connector terminal, and the substrate 1 is a copper substrate or a copper alloy substrate.

In another exemplary embodiment of the present invention, a connector is disclosed. The connector includes a housing and the afore-mentioned electroplated part. The electroplated part is disposed in the housing and serves as a terminal of the connector.

The present disclosure relates to a multi-layer plating structure with a low friction coefficient, which adopts a nickel plating layer as an underlayer, a tin-graphite composite plating layer as an intermediate layer, and a tin plating layer as the outermost layer. This multi-layer structure exhibits an extremely low friction coefficient, excellent wear resistance, as well as favorable corrosion resistance and structural stability. The disclosure aims to enhance the comprehensive performance of the plating structure and can partially or completely replace conventional processes such as tin electroplating and nickel and tin electroplating currently in common use. Implementing this plating structure can significantly reduce the friction coefficient of the plating, decrease insertion and mating forces of connector terminals, while maintaining the plating's conductivity and corrosion resistance unchanged. The comprehensive performance of the plating structure becomes more stable. Simultaneously, it ensures more stable retention of graphite within the plating structure, reducing susceptibility to displacement or detachment due to external contact.

The electroplated part of the present invention may serve as a connector terminal. The plating structure can replace existing tin plating and nickel and tin plating layers. The plating structure of the present invention can be applied to any metallic or non-metallic substrate and is compatible with any electroplating method (including conventional barrel plating, rack plating, high-speed reel-to-reel plating, and including both full plating and selective plating).

Building upon existing tin-graphite composite plating layers, the present invention develops a multi-layer composite structure comprising a nickel plating layer, a tin-graphite composite plating layer and a tin plating layer. The nickel plating layer serves as the underlayer, functioning both as a barrier to prevent upward diffusion of substrate atoms and as a rigid support layer that exerts an anvil effect, further reducing the friction coefficient of the tin-graphite composite plating layer. The intermediate tin-graphite composite plating layer utilizes the lubricating properties of graphite to substantially decrease the material's friction coefficient, reduce terminal insertion force, and enhance wear resistance. The outermost tin plating layer partially or completely wraps graphite particles exposed from the tin-graphite composite plating layer. This not only increases the stability of graphite particles within the plating structure and reduces the risk of graphite particle detachment, improving the wear resistance, corrosion resistance and service life of the electroplated part, but also decreases surface roughness and mitigates susceptibility to galvanic corrosion.

In the multi-layer composite structure of the present invention, the underlying nickel plating layer has a thickness of 0.5-2.5 μm, the intermediate tin-graphite composite plating layer has a thickness of 0.5-15 μm, with graphite particle sizes of 0.5-5 μm, and the outermost tin plating layer has a thickness of 0.5-5 μm. The thickness of the outermost tin plating layer may be less than, equal to, or greater than the maximum diameter of graphite particles. This enables partial or complete wrapping of graphite particles exposed on the surface of the tin-graphite composite plating layer by the outermost tin plating layer.

The nickel plus tin-graphite and tin multi-layer structure of the present invention achieves a friction coefficient comparable to that of tin-graphite composite plating layers and exhibits excellent wear resistance. Simultaneously, graphite remains stably wrapped within the plating layer, resists detachment, and delivers more stable and durable performance. Its corrosion resistance is also significantly improved.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. An electroplated part, comprising:
a substrate;
a nickel plating layer formed on a surface of the substrate, the nickel plating layer is a base plating layer of the substrate;
a tin-graphite composite plating layer formed on the nickel plating layer; and
a tin plating layer formed on the tin-graphite composite plating layer, the tin plating layer is an outer plating layer of the substrate and the tin-graphite composite plating layer is an intermediate plating layer of the substrate.

2. The electroplated part according to claim 1, wherein at least one of a plurality of graphite particles in the tin-graphite composite plating layer is exposed from a surface of the tin-graphite composite plating layer.

3. The electroplated part according to claim 2, wherein the at least one of the graphite particles exposed from the surface of the tin-graphite composite plating layer is partially or completely wrapped with the tin plating layer.

4. The electroplated part according to claim 3, wherein a thickness of the tin plating layer is less than a maximum diameter of the graphite particles in the tin-graphite composite plating layer, and the tin plating layer only partially wraps the at least one of the graphite particles exposed from the tin-graphite composite plating layer.

5. The electroplated part according to claim 3, wherein a thickness of the tin plating layer is equal to or greater than a maximum diameter of the graphite particles in the tin-graphite composite plating layer, and the tin plating layer completely wraps the at least one of the graphite particles exposed from the tin-graphite composite plating layer.

6. The electroplated part according to claim 3, wherein the nickel plating layer has a thickness of 0.5-2.5 μm, the tin-graphite composite plating layer has a thickness of 0.5-15 μm, the tin plating layer has a thickness of 0.5-5 μm, and the graphite particles in the tin-graphite composite plating layer have a diameter of 0.5-5 μm.

7. The electroplated part according to claim 1, wherein the substrate is a conductive substrate or a non-conductive substrate.

8. The electroplated part according to claim 7, wherein the substrate is a metal substrate or a non-metal substrate.

9. The electroplated part according to claim 1, wherein the electroplated part is a connector terminal, and the substrate is a copper substrate or a copper alloy substrate.

10. The electroplated part according to claim 1, wherein the nickel plating layer, the tin-graphite composite plating layer, and the tin plating layer are selectively electroplated onto a local region of the substrate or on an entire surface of the substrate.

11. A method for manufacturing an electroplated part, comprising the steps of:
providing a substrate;
forming a nickel plating layer on the substrate, the nickel plating layer is a base plating layer of the substrate;
forming a tin-graphite composite plating layer on the nickel plating layer; and
forming a tin plating layer on the tin-graphite composite plating layer, the tin plating layer is an outer plating layer of the substrate and the tin-graphite composite plating layer is an intermediate plating layer of the substrate.

12. The method for manufacturing an electroplated part according to claim 11, wherein the step of providing the substrate includes removing dirt and grease from a surface of the substrate, and pickling and activating the substrate.

13. The method for manufacturing an electroplated part according to claim 12, wherein removing dirt and grease from the surface of the substrate includes subjecting the substrate to degreasing by cathodic electrolysis for 1 minute by using a direct current having a current density of 2 A/dm².

14. The method for manufacturing an electroplated part according to claim 13, wherein the substrate is pickled and activated in 5% dilute sulfuric acid.

15. The method for manufacturing an electroplated part according to claim 11, wherein forming the nickel plating layer on the substrate includes:
preparing a nickel aminosulfonate electroplating solution and heating the nickel aminosulfonate electroplating solution to 60° C.;
placing the substrate into the nickel aminosulfonate electroplating solution and electroplating the substrate by using a direct current having a current density of 2 A/dm²; and
taking out the substrate from the nickel aminosulfonate electroplating solution and cleaning the substrate with deionized water.

16. The method for manufacturing an electroplate part according to claim 11, wherein forming the tin-graphite composite plating layer includes:
preparing a tin methanesulfonate-graphite electroplating solution, a graphite is flaky graphite and has an average particle size of 3-5 μm, and a graphite content is 20 g/L;
mechanically stirring the tin methanesulfonate-graphite electroplating solution until the graphite is uniformly dispersed in the tin methanesulfonate-graphite electroplating solution;
heating the tin methanesulfonate-graphite electroplating solution to 55° C. and placing the substrate that has been plated with the nickel plating layer into the tin methanesulfonate-graphite electroplating solution;
subjecting the substrate to tin-graphite composite plating using a pulsed current having a peak current density of 5-40 A/dm², a pulse width of 10 ms and a duty cycle of 2%; and
taking out the substrate from the tin methanesulfonate-graphite electroplating solution and cleaning the substrate with deionized water.

17. The method for manufacturing an electroplated part according to claim 11, wherein forming the tin plating layer includes:
preparing a tin methanesulfonate electroplating solution and heating the tin methanesulfonate electroplating solution to 55° C.;
placing the substrate which has been plated with the nickel plating layer and the tin-graphite composite plating layer into the tin methanesulfonate electroplating solution;
electroplating the substrate by using a direct current having a current density of 2 A/dm²for 60 to 120 seconds; and
taking out the substrate from the tin methanesulfonate electroplating solution, cleaning the substrate with deionized water, and air drying the substrate by using an air drying device.

18. The method for manufacturing an electroplated part according to claim 11, wherein the electroplated part is a connector terminal, and the substrate is a copper substrate or a copper alloy substrate.

19. A connector, comprising:
a housing; and
an electroplated part disposed in the housing as a terminal of the connector, the electroplated part includes a substrate, a nickel plating layer formed on a surface of the substrate, the nickel plating layer is a base plating layer of the substrate, a tin-graphite composite plating layer formed on the nickel plating layer, a tin plating layer formed on the tin-graphite composite plating layer, the tin plating layer is an outer plating layer of the substrate and the tin-graphite composite plating layer is an intermediate plating layer of the substrate.
